(19) United States
(12) Patent Application Publication
(10) Pub. No.: US 2002/0041676 A1
(43) Pub. Date: Apr. 11, 2002

(54) POTS splitter

(76) Inventors: John E. DeCramer, Marshall, MN (US); Nathan Doose, Granite Falls, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/791,163

(22) Filed: Feb. 22, 2001

Related U.S. Application Data
(60) Provisional application No. 60/184,082, filed on Feb. 22, 2000.

(51) Int. Cl. H04M 1/00; H04M 9/00

(52) U.S. Cl. 379/399.01

(57) ABSTRACT

A POTS splitter of the present invention generally include a telephone line interface, a data receiver interface that is connected to the telephone line interface, and a low pass filter that is connected to the telephone line interface. The low pass filter operates to pass only those frequencies that are lower than 4 Khz. And, the entire configuration of a single line POTS splitter is maintainable upon a circuit board that is no greater than 2.0 inches by 1.5 inches, with a maximum depth of 0.630 inches. The POTS splitter is operational in the temperature range of −40° to +70° C.

### CLAIM TO PRIORITY

The present application claims priority to U.S. provisional application having serial No. 60/184,082, filed Feb. 22, 2000, and entitled “Signal Splitter”. The identified provisional patent application is hereby incorporated by reference.

### FIELD OF THE INVENTION

The present invention relates to POTS (plain old telephone service) systems that carry both voice and data transmissions and, more particularly, to a device for splitting the frequency of the POTS system to separate or split a transmission into their respective voice and data components.

### BACKGROUND OF THE INVENTION

The plain old telephone service, or POTS, is the service that delivers analog voice signals to a user's home or office. These analog voice signals are generally transmitted at a frequency of less than 4 kHz. The same twisted pair of wires that carry the analog voice signals are also capable of carrying digital signals albeit at higher frequencies than the analog voice signals, e.g., 4 kHz to 1.1 MHz. To enable operation of both POTS and a digital subscriber line (xDSL) a splitter is used to divide or split the analog and digital signals.

Depending on the type of DSL a splitter may be required at both a remote location, i.e., the customer premise, and at the central office (CO) location. For example, with asymmetric DSL, or ADSL, both are required. In this instance, the remote POTS splitter splits the incoming telephone signal into a low frequency signal for voice devices by utilizing a low pass filter and into a high frequency data signal for computers. Meanwhile, the CO POTS splitter splits its incoming signal into a low frequency voice signal for the public switched telephone network (PSTN) by utilizing a low pass filter and into a high frequency signal for a DSL access multiplexor to direct the signal to the internet.

To make voice and xDSL widely available to the general public there is a need for the POTS splitters at both the central office and at the customer premise be cost-effective, of a minimally intrusive size, easily installed, as well as durable and reliable over a range of temperatures.

### SUMMARY OF THE INVENTION

The needs described above are in large measure met by the POTS splitter of the present invention. The POTS splitter generally include a telephone line interface, a data receiver interface that is connected to the telephone line interface, and a low pass filter that is connected to the telephone line interface. The low pass filter operates to pass only those frequencies that are lower than 4 Khz. And, the entire configuration of a single line POTS splitter is maintainable upon a circuit board that is no greater than 2.0 inches by 1.5 inches, with a maximum depth of 0.630 inches. The POTS splitter is operational in the temperature range of −40° to +70° C.

The low pass filter is composed of a minimal number of components, i.e. a common mode choke, a first mutual inductor, a second mutual inductor, an inductor, a first capacitor and a second capacitor. In the instance that the POTS splitter is a central office (CO) POTS splitter, rather than a remote POTS splitter, a pair of DC blocking capacitors are placed between the telephone line and the data receiver.

### DESCRIPTION OF THE DRAWINGS

FIG. 1 is a block diagram of a remote POTS splitter of the present invention.

FIG. 2 is a block diagram of a central office (CO) POTS splitter of the present invention.

FIG. 3 is a circuit diagram of the remote POTS splitter of the present invention.

FIGS. 4A and 4B provide a view of the remote POTS splitter of FIG. 3 with the actual components mounted on a circuit board.

FIG. 5 is a circuit diagram of the CO POTS splitter of the present invention.

FIG. 6 is a front view of a line card incorporating a plurality of the CO POTS splitters of FIG. 5.

FIG. 7 is a side view of the line card of FIG. 6.

FIG. 8 is provides a front view of a multiple slot chassis for accepting a plurality of the line cards of FIGS. 6 and 7.

### DESCRIPTION OF THE PREFERRED EMBODIMENTS

A remote POTS splitter and central office (CO) POTS splitter of the present invention operate to divide a telephone signal into signals of different frequencies. The splitters perform this operation through the use of a filter whose number of components are limited and whose operation is reliable through a range of temperatures.

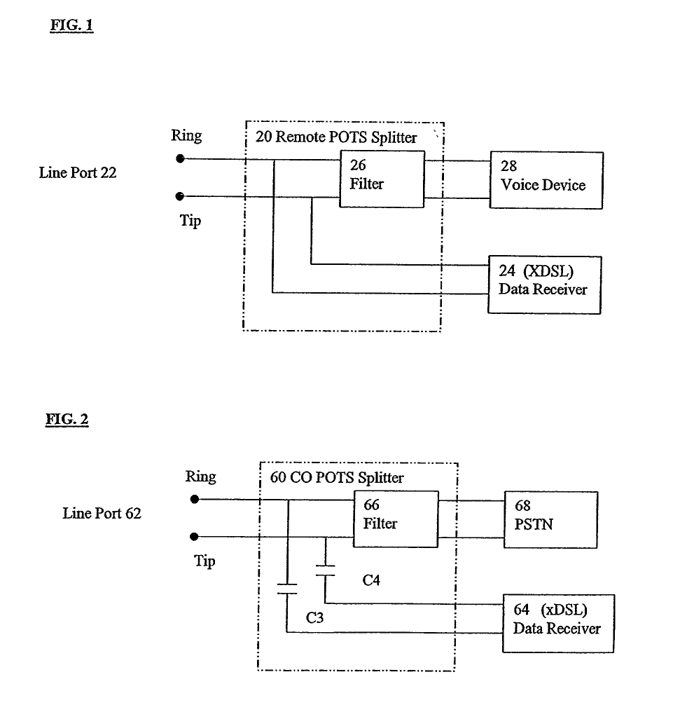

Referring to FIG. 1 a block diagram of the remote POTS splitter 20 of the present invention is provided. As shown, an incoming telephone line 22 is provided at remote POTS splitter 20 and is tapped to provide the high frequency xDSL signal to a data receiver 24, e.g., xDSL modem. Line 22 is also directed to a low pass filter 26 whereby the high frequency xDSL signal is filtered out allowing only the low frequency voice signal to pass to the user's voice device 28.

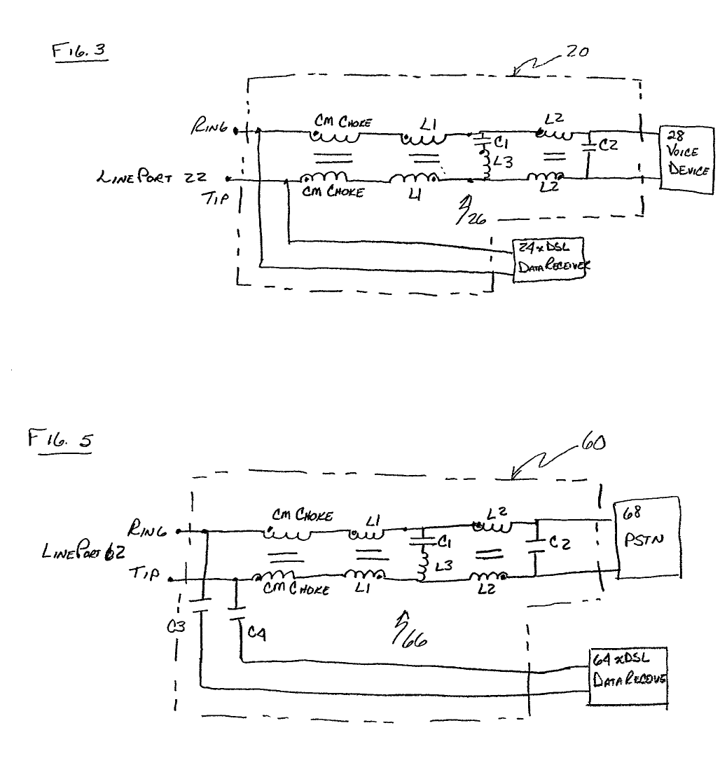

Referring to FIG. 2 a block diagram of the central office (CO) POTS splitter 60 of the present invention is provided. As shown an incoming line 62 from a user's premise is provided at CO POTS splitter 60 and is tapped to provide the high frequency xDSL signal to a data receiver 64, e.g., DSL access multiplexor or modem. However, prior to passing the high frequency signal to data receiver 64, the signal is passed through a pair of DC blocking capacitors, C3 and C4. Line 62 is also directed to low pass filter 66 whereby the high frequency xDSL signal is filtered out allowing only the low frequency voice signal to pass to the public switched telephone network (PSTN) 66.

The purpose of low pass filters 26 and 66 is two-fold. First, for xDSL signals, protection from the high frequency transients and impedance effects that occur during POTS operation—ringing transients, ring trip transients, and off-hook transients and impedance changes—is provided. For POTS voice band service, the low pass filters provide protection from xDSL signals which may impact through non-linear or other effects remote devices (handset, fax, voice band modem, etc.) and central office operation.

Referring to FIG. 3, a circuit diagram of remote POTS splitter 20 is provided. As shown, line 22 enters splitter 20 and is tapped to provide the high frequency signal to xDSL data receiver 24 without intervention of additional circuitry. Line 22 is also provided to low pass filter 26 where xDSL frequencies are filter out. As shown, filter 26 includes a common-mode choke, CM Choke, which is used to eliminate noise on line 22. Filter 26 further includes a mutual inductor L1 that is preferably in the configuration of an RM-6 core, which is connected to the series combination of capacitor C1 and inductor L3. A second mutual inductor L2 that is preferably in the configuration of an RM-6 core is connected between the series combination and a capacitor C2.

TABLE 1

| Component | Preferred Embodiment | Alternative Embodiment |
|---|---|---|
| CM Choke | 835 uH per inductor | 835 uH per inductor |
| L1 | 6.8 mH per inductor | 6.0 mH per inductor |
| C1 | 0.056 uF | 0.047 uF |
| L3 | 434 uH | 590 uH |
| L2 | 6.8 mH per inductor | 6.0 mH per inductor |
| C2 | 0.033 uF | 0.027 uF |

Of course, other component values may be used without departing from the spirit or scope of the invention.

The preferred embodiment of filter 26 preferably utilizes magnetic materials exhibiting a 2000 permeability, with the CM choke using a core of higher permeability. When utilizing the specified magnetic material and the component values listed in Table 1, the preferred embodiment of filter 26 and resulting POTS splitter 20 meets with ANSI specification T1E1.4/98-007R5 Annex E, the contents of which is hereby incorporated by reference. The use of lower permeability materials and tight tolerances on final inductance allows this embodiment of POTS splitter 20 to work properly across a full range of temperatures from −40° C. to +70° C.

The alternative embodiment of filter 26 preferably uses magnetic materials exhibiting a 2000 permeability (L1, L2, L3), CM choke utilizing a higher permeability, to achieve the proper operational characteristics and compliance with ANSI specification T1E1.4/98-007R5 Annex E.

Specifically, each embodiment of POTS splitter 20 meets the following electrical specifications:

1. Open Circuit Inductance: 51.7 mH-58.5 mH 1.2 KHz 100 mV (across line 22 short).

2. Interwinding Capacitance: 100 nF MAX. 25 Hz 100 mV.

3. DC Resistance: 8.45-9.34 Ohms 0.250 Ohms MAX difference between tip and ring of line 22.

4. High Voltage Test: 275 VDC (tip to ring).

5. −600-900 Ohm Test: <−1.0 dB @ 1 KHz.

3 dB attenuation @ 7.5 KHz ±1.25 KHz

50 dB attenuation min. @ 21 KHz

±1.5 dB Max. from 200 Hz-3.4 KHz with respect to 1 KHz

±2.0 dB max. from 3.4 KHz-4.0 KHz with respect to 1 KHz.

6. −600-100 Ohm Test: 65 dB attenuation min. from 26.5 KHz-300 KHz

55 dB attenuation min. from 300 KHz-1.2 MHz.

72 dB attenuation min. from 35 KHz-75 KHz.

Remote POTS splitter 20 may be provided with terminals or flying leads for connection to line 22, data receiver 24 and voice device 28. Alternatively, remote POTS splitter 20 may be provided with RJ-11 interfaces for quick installation by a professional or user. In either instance, remote POTS splitter 20 may be mounted indoors or outdoors within a housing.

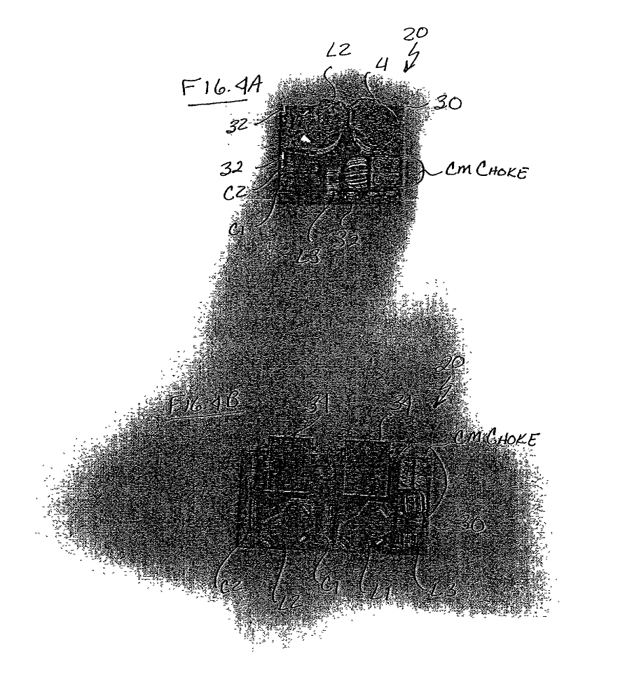

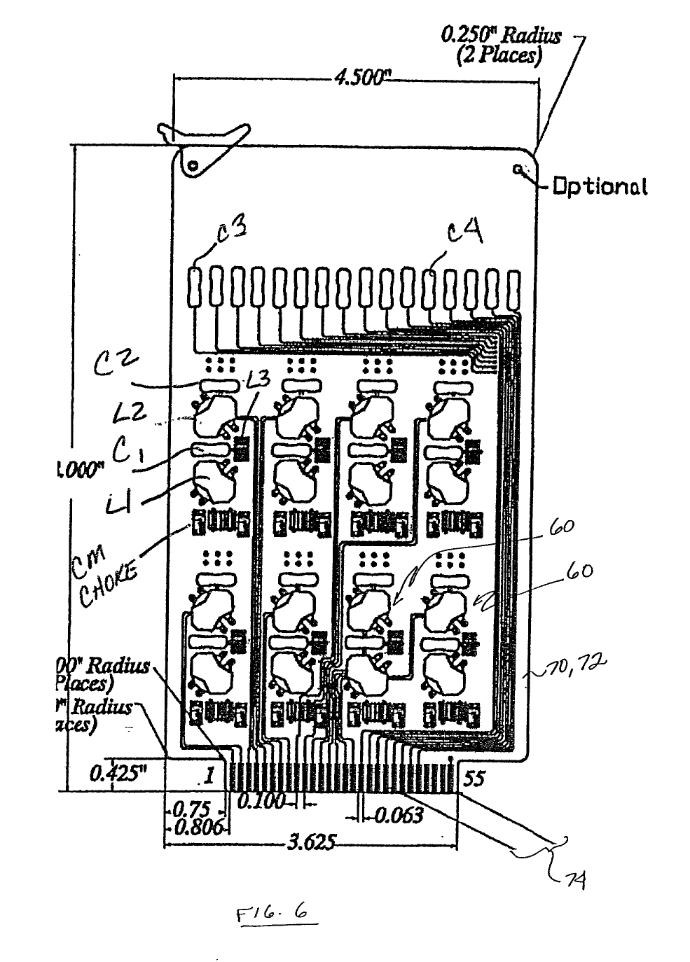

FIG. 4A provides a view of remote POTS splitter 20 as mounted atop a circuit board 30 wherein terminals 32 are provided. This view of remote POTS splitter 20 shows the compact nature of the splitter (approximately 1.325 inches by 1.0625 inches) and the reduced number of components necessary to implement its operation. FIG. 4B provides a view of remote POTS splitter 20 wherein RJ-11 interfaces 34 are provided, the size of circuit board 30 having been slightly increased (2.0 inches by 1.0625 inches). In each configuration the overall depth of POTS splitter is approximately 0.630 inches.

Referring to FIG. 5 a circuit diagram of CO POTS splitter 60 is provided. As can be seen, CO POTS splitter 60 is identical to remote POTS splitter 20 with the exception that DC blocking capacitors C3 and C4 have been added between line 62 xDSL data receiver 64. Capacitors C3 and C4 are each preferably 0.12 uF. Filter 66 component values, operation, and electrical specifications are identical to those provided above in with respect to filter 26.

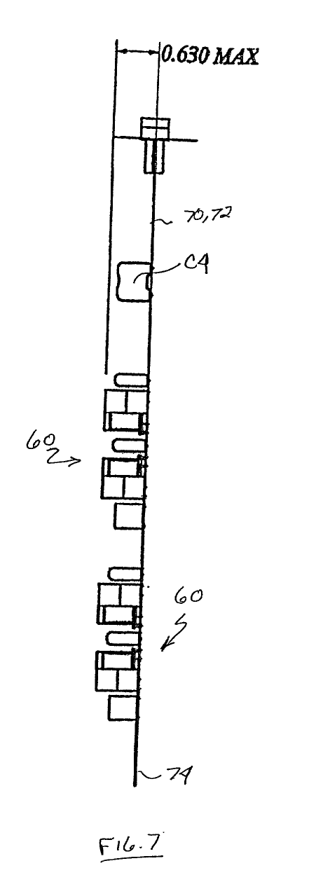

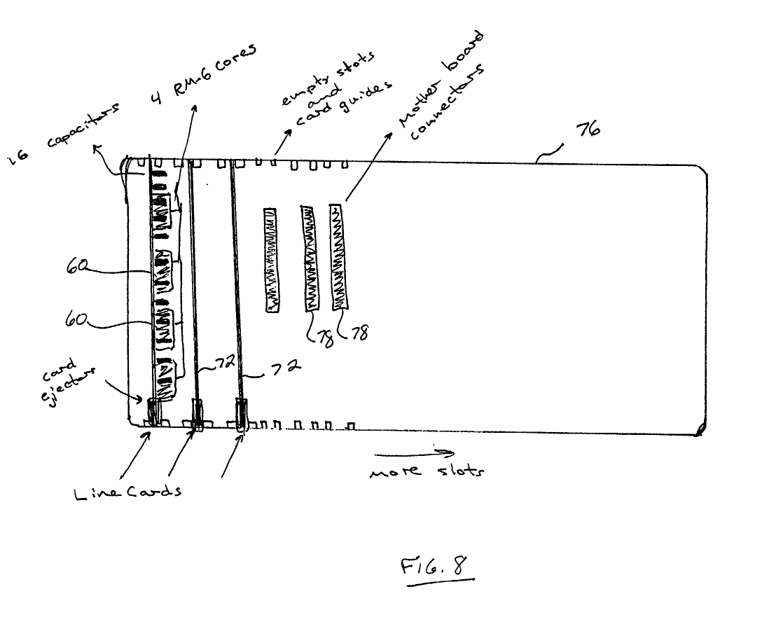

FIGS. 6 and 7 provide a view of a plurality of CO POTS splitters 60 mounted atop a circuit board 70 that is provided as a line card 72. In this preferred embodiment, eight CO POTS splitters 60 are mounted atop board 70 which is additionally provided with gold interface terminals 74. Once again, the compact nature of splitter 60 can be appreciated as eight CO POTS splitters are able to occupy a line card 72 that is only 4.5 inches by 8.0 inches, with an overall maximum circuit depth of 0.630 inches.

FIG. 8 provides a front view of a multiple slot chassis 76 for accepting a plurality of the line cards 72, whereby the line cards 72 interface with a mother board connector 78.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

What is claimed:

1. A plain old telephone service (POTS) splitter, said splitter comprising:
a telephone line interface;
a data receiver interface connected to said telephone line interface
a low pass filter connected to said telephone line interface, wherein said low pass filter operates to pass only those frequencies below 4 KHz;
wherein said POTS splitter is maintained upon a circuit board that is no greater than 2.0 inches by 1.5 inches.

2. The splitter of claim 1, wherein said splitter is a remote POTS splitter that utilizes a terminal telephone line interface.

3. The splitter of claim 2, wherein said splitter is maintained upon a circuit board that is no greater than 1.4 by 1.1 inches.

4. The splitter of claim 1, wherein said splitter is a remote POTS splitter that utilizes an RJ-11 telephone line interface.

5. The splitter of claim 4, wherein said splitter is maintained upon a circuit board that no greater than 2.0 inches by 1.1 inches.

6. The splitter of claim 1, wherein said low pass filter utilizes less than eight electronic components.

7. The splitter of claim 6, where said less than eight electronic components are selected from a group consisting of:
an RM-6 mutual inductor, a common mode choke, an inductor, and a capacitor.

8. The splitter of claim 1, wherein said splitter is operational in the temperature range of −40° to +70° C.

9. A plain old telephone service (POTS) splitter, said splitter comprising:
a telephone line interface;
a data receiver interface connected to said telephone line interface; and
a low pass filter connected to said telephone line interface, wherein said low pass filter operates to pass only those frequencies below 4 KHz,
wherein said POTS splitter is a central office (CO) splitter, and wherein at least eight CO splitters are maintained on a circuit board no greater than 8.0 inches by 4.5 inches.

10. The splitter of claim 9, wherein said splitter is maintain on said circuit board with a depth no greater than 0.630 inches.

11. The splitter of claim 9, wherein said filter includes a common mode choke, a first mutual inductor, a second mutual inductor, an inductor, a first capacitor and a second capacitor.

12. The splitter of claim 9, wherein said filter consists of a common mode choke, a first mutual inductor, a second mutual inductor, an inductor, a first capacitor and a second capacitor.

13. The splitter of claim 11, wherein said splitter includes a pair of DC blocking capacitors.

14. The splitter of claim 12, wherein said splitter includes a pair of DC blocking capacitors.

15. The splitter of claim 9, wherein said splitter is operational in the temperature range of −40° to +70° C.

16. A plain old telephone service (POTS) splitter, said splitter comprising:
a telephone line interface;
a data receiver interface connected to said telephone line interface; and
a low pass filter connected to said telephone line interface, wherein said low pass filter operates to pass only those frequencies below 4 KHz, and wherein said low pass filter includes a common mode choke, a first mutual inductor, a second mutual inductor, an inductor, a first capacitor and a second capacitor.

17. The splitter of claim 16, wherein said low pass filter consists of a common mode choke, a first mutual inductor, a second mutual inductor, an inductor, a first capacitor and a second capacitor.

18. The splitter of claim 16, wherein said splitter includes a pair of DC blocking capacitors.

19. The splitter of claim 17, wherein said splitter includes a pair of DC blocking capacitors.

20. The splitter of claim 16, wherein said first mutual inductor and said second mutual inductors are in an RM-6 configuration.

21. The splitter of claim 16, wherein said splitter is operational in the temperature range of −40° to +70° C.
